(19) United States
(12) Patent Application Publication
(10) Pub. No.: US 2022/0041131 A1
(43) Pub. Date: Feb. 10, 2022

(54) COLLABORATIVE VEHICLE SECURITY SYSTEM AND VEHICLE SECURITY DEVICE

(71) Applicants: Fong-Shou LEE, Taipei City (TW); Yu-Cheng LEE, Taipei City (TW); Si-Cheng LEE, Taipei City (TW)

(72) Inventors: Fong-Shou LEE, Taipei City (TW); Yu-Cheng LEE, Taipei City (TW); Si-Cheng LEE, Taipei City (TW)

(21) Appl. No.: 17/389,038

(22) Filed: Jul. 29, 2021

(30) Foreign Application Priority Data
Aug. 6, 2020 (TW) 109126680
Jul. 7, 2021 (TW) 110125047

(51) Int. Cl. B60R 25/10; B60R 25/102

(52) U.S. Cl. CPC B60R 25/1012; B60R 25/102

(57) ABSTRACT

A vehicle security device includes a control module, a detection module, a communication module, and an alarm module. The control module is installed in a vehicle. The detection module is configured to detect at least one safety abnormal event of the vehicle. The communication module is configured to optionally output or receive at least one collaborative alarm activation signal. The alarm module is configured to output a warning alarm. When the detection module detects out the safety abnormal event, the control module generates at least one abnormal alarm activation signal and the collaborative alarm activation signal, the alarm module outputs the warning alarm according to the abnormal alarm activation signal, and the communication module outputs the collaborative alarm activation signal. When the communication module receives the collaborative alarm activation signal, the alarm module outputs the warning alarm according to the collaborative alarm activation signal.

### CROSS REFERENCE TO RELATED APPLICATIONS

This Non-provisional application claims priority under 35 U.S.C. § 119(a) on Patent Application No(s). 109126680 filed in Taiwan, Republic of China on August 6, 2020 and 110125047 filed in Taiwan, Republic of China on Jul. 7, 2021, the entire contents of which are hereby incorporated by reference.

### BACKGROUND

### Technology Field

The present disclosure relates to a vehicle security system and, in particular, to a collaborative vehicle security system that establishes communications between the vehicle security devices installed on neighboring vehicles for sharing the abnormal warning.

### Description of Related Art

Most of the conventional anti-theft systems for vehicles are installed on the vehicle by the owner. The alarm is triggered by sensor to deter the thief. However, some thieves who know the technology of the anti-theft device can eliminate the alarm in a very short time so as to successfully steal the valuables in the vehicle.

Some parking lots or parking garages also provide functions of detecting abnormal state of parking space and notifying the manager, so as to intercept the stolen vehicles at the exit of the parking lots or garages, or notify the manager to arrive at the parking space that triggered the alarm to see what is happened. However, the manager of parking lots or garages may not be able to go to or arrive at the parking space that triggered the alarm in time for some reasons, so it is inevitable that important materials in the vehicles will be stolen.

Therefore, it is desired to provide a vehicle security system and a vehicle security device that can enhance the deterrence ability to achieve the anti-theft and anti-robbing function of vehicles.

### SUMMARY

An objective of this disclosure is to provide a collaborative vehicle security system and a vehicle security device that can enhance the deterrence ability to achieve the anti-theft and anti-robbing function of vehicles.

To achieve the above, a vehicle security device of this disclosure is applied to a vehicle and comprises a control module, a detection module, a communication module, and an alarm module. The control module is installed in the vehicle. The detection module is connected to the control module and configured to detect at least one safety abnormal event of the vehicle. The communication module is connected to the control module and configured to optionally output or receive at least one collaborative alarm activation signal. The alarm module is configured to output a warning alarm. When the detection module detects out the safety abnormal event, the control module generates at least one abnormal alarm activation signal and the collaborative alarm activation signal, the alarm module outputs the warning alarm according to the abnormal alarm activation signal, and the communication module outputs the collaborative alarm activation signal. When the communication module receives the collaborative alarm activation signal, the alarm module outputs the warning alarm according to the collaborative alarm activation signal.

In one embodiment, the vehicle security device further comprises an alarm relieve module for accepting a relieve operation to relieve the warning alarm outputted by the alarm module.

In one embodiment, the vehicle security device further comprises a timing module configured to provide at least one time stamp, which is corresponding to at least one of the safety abnormal event, the collaborative alarm activation signal, the warning alarm, and the abnormal alarm activation signal.

In one embodiment, the communication module further retransmits the received collaborative alarm activation signal.

In one embodiment, the vehicle security device outputs at least one warning signal to a mobile communication device, and the warning signal comprises at least one of the safety abnormal event, the collaborative alarm activation signal, the warning alarm, and the abnormal alarm activation signal.

To achieve the above, the present disclosure also provides a collaborative vehicle security system, which comprises a plurality of the above-mentioned vehicle security devices. When one of the vehicle security devices outputs the collaborative alarm activation signal, another one of the vehicle security devices receives the collaborative alarm activation signal, and outputs the warning alarm according to the received collaborative alarm activation signal.

In one embodiment, each vehicle security device further comprises an alarm relieve module. When the alarm relieve module of the vehicle security device outputting the warning alarm accepts a relieve operation, the vehicle security device relieves the warning alarm and notifies another vehicle security device receiving the collaborative alarm activation signal to relieve the warning alarm thereof simultaneously.

In one embodiment, each vehicle security device further comprises a timing module configured to provide at least one time stamp, and the time stamp is corresponding to at least one of the safety abnormal event, the collaborative alarm activation signal, the warning alarm, and the abnormal alarm activation signal.

In one embodiment, the intensity of the warning alarm is variable based on the distance between the vehicle security device outputting the warning alarm and a signal source of the collaborative alarm activation signal.

In one embodiment, the vehicle security device receiving the collaborative alarm activation signal further retransmits the received collaborative alarm activation signal.

In one embodiment, each vehicle security device outputs at least one warning signal to a mobile communication device, and the warning signal comprises at least one of the safety abnormal event, the collaborative alarm activation signal, the warning alarm, and the abnormal alarm activation signal.

In one embodiment, each vehicle security device further comprises an alarm relieve module. The user of the mobile communication device moves toward the vehicle security device outputting the warning alarm according to the received warning signal and performs a relieve operation to relieve the warning alarm of the vehicle security device.

In one embodiment, the collaborative vehicle security system further gifts a gratitude bonus to the user who performed the relieve operation.

In one embodiment, the collaborative vehicle security system further comprises a database recording registration information of each of the vehicle security devices. The warning signal further comprises the registration information of the vehicle security device outputting the collaborative alarm activation signal.

In one embodiment, the collaborative vehicle security system further comprises at least one central control host and at least one router signally connected to the central control host. Each of the vehicle security devices is signally connected to the central control host directly or signally connected to the central control host through the router, so that the vehicle security device outputs the warning signal to the corresponding mobile communication device via the central control host.

In one embodiment, the central control host provides a parking-area partition function, and the routers are arranged in different parking areas, respectively.

As mentioned above, the collaborative vehicle security system and vehicle security device of this disclosure can establish the communication connections between the neighboring vehicles in the parking lots or garages, and the neighboring vehicles with communication connections can be grouped as one collaborative security group. Accordingly, the group members (the vehicles or the vehicle security devices) of the collaborative security group can share the information such as the safety abnormal event, the collaborative alarm activation signal, and/or the abnormal alarm activation signal. When one of the vehicles (vehicle security devices) senses the safety abnormal event, it will share the alarm activation signal with other vehicles (vehicle security devices) in the same collaborative security group, and these vehicles (vehicle security devices) will output warning alarms at the same time. At this time, the loud warning alarms (from multiple vehicles) can deter thieves and stop the possible crime events. In addition, the collaborative alarm activation signal can be transmitted or used to notify other users of the same collaborative security group and the manager of parking lot or garages, so that the users and manager can immediately and appropriately act based on the received collaborative alarm activation signal to eliminate the abnormal alarm. This is a multiple-to-multiple creative value-added anti-theft service. In general, the thief usually steals one car after one another and expects to return with a full load. Therefore, by sharing the abnormal alarm, the vehicle invaded by the thief can immediately receive the first-moment loud deterrent support from all other vehicles in the same collaborative security group. Besides, the other vehicle owners in the collaborative security group(s) are also afraid that their properties may be the next target of theft, so of course they are willing to share the abnormal alarms with other vehicle owners who do not know each other. According the system of this disclosure, there will be multiple vehicles turning on the loud warning alarms to deter thieves, and then the multiple vehicle owners may return to the parking lots to check what is happened, confirm and/or help eliminate abnormal alarm, and the multiple vehicle owners can collaborate with police at critical moment to catch the thief.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a block diagram showing a collaborative vehicle security system according to a first embodiment of this disclosure;

FIG. 2 is a schematic diagram showing the collaborative security groups of the collaborative vehicle security system according to the first embodiment of this disclosure;

FIG. 3 is a schematic diagram showing the collaborative vehicle security system, which further comprises central control routers, according to the first embodiment of this disclosure;

FIG. 4 is a schematic diagram showing the configuration of the alarm relieve module of the collaborative vehicle security system according to the first embodiment of this disclosure;

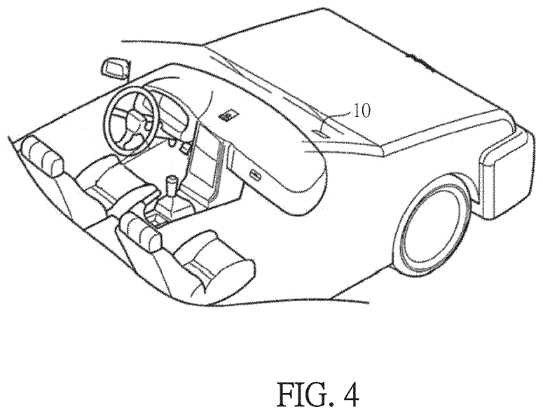

FIG. 5 is a schematic diagram showing a vehicle security device according to a second embodiment of this disclosure;

FIG. 6A is a schematic diagram showing a collaborative vehicle security system according to a second embodiment of this disclosure; and

FIG. 6B is a schematic diagram showing the collaborative vehicle security system, which further comprises routers, according to the second embodiment of this disclosure.

### DETAILED DESCRIPTION OF THE DISCLOSURE

The present disclosure will be apparent from the following detailed description, which proceeds with reference to the accompanying drawings, wherein the same references relate to the same elements.

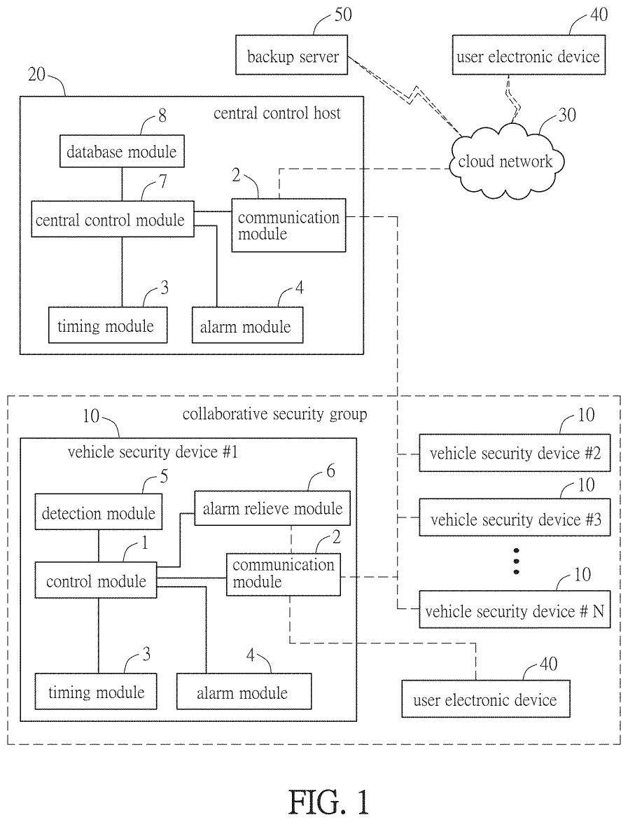

FIG. 1 is a block diagram showing a collaborative vehicle security system according to a first embodiment of this disclosure. Referring to FIG. 1, the collaborative vehicle security system is composed of one or more vehicle security devices 10 and one central control host 20. Each vehicle security devices 10 comprises a control module 1, a communication module 2, a timing module 3, an alarm module 4, a detection module 5, and an alarm relieve module 6. The central control host 20 comprises a central control module 7, a communication module 2, a timing module 3, an alarm module 4, and a database module 8.

At first, the vehicle owner will install a vehicle security device 10 in his/her vehicle, and register the vehicle and the installed vehicle security device 10 to the collaborative vehicle security system. When the registered vehicle arrives the entrance of a parking lots, the central control host 20 can signally connect to the vehicle security device 10 through the communication module 2 to check whether this vehicle is registered or not, and to automatically obtain the required information with respect to the installed and registered vehicle security device 10. Herein, the obtained information may include the contact information, the license plate number, and/or the automatic payment information, which can be used in the following notification procedure and payment procedure. In addition, the central control host 20 also returns the entrance time, the parking serial number, the network information of parking lots to the vehicle security device 10, and the vehicle security device 10 will save the returned information. In this embodiment, the alarm module 4 will flash green light (e.g. flash 5 times per second) to indicate that the first step of parking is completed. After the vehicle enters the parking lots and is parked in the parking space, the user electronic device 40 of the vehicle owner communicates with the communication module 2 of the vehicle security device 10 to obtain the information from the central control host 20, such as the entrance time, the parking serial number, the network information, or the likes. For example, this communication can be carried out by the APP installed on the user electronic device 40. Then, the vehicle owner can press a confirm button to join a collaborative security group. In this embodiment, the alarm module 4 of the vehicle security device 10 will flash green light in another frequency (e.g. flash once per second) so as to finish a second step of parking. Afterwards, the communication module 2 outputs the confirm information and the IP address of the user electronic device 40 to the central control host 20, which can notify the system that the vehicle owner agrees to use the service of the collaborative vehicle security system. The IP address of the user electronic device 40 can be used in the following broadcasting of abnormal warning alarm.

In addition, after the first step of parking and the green light starts to flash for 5 times per second, the vehicle owner can use a registered ID card or press buttons to reply the confirm information, which can notify the system that the vehicle owner agrees to use the service of the collaborative vehicle security system, via the alarm relieve module 6 of the vehicle security device 10.

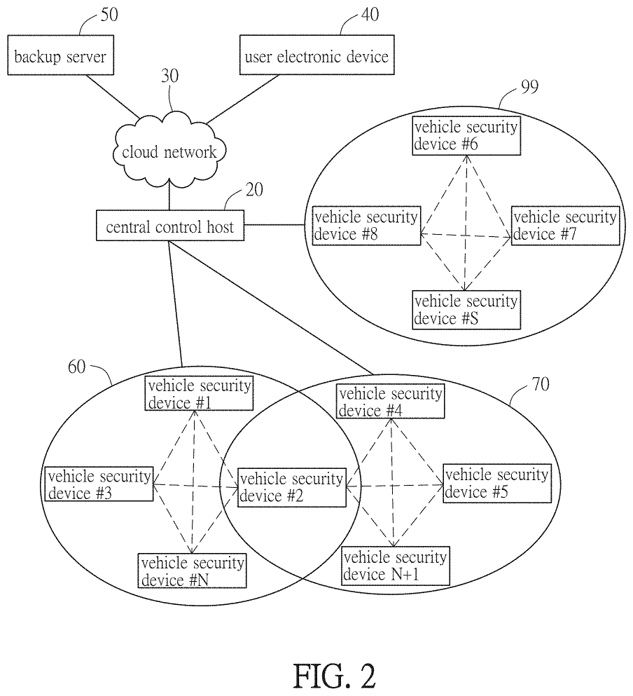

Referring to FIG. 2, the communication module 2 of the vehicle security device 10 can communicate with the neighboring vehicles (the communication module 2 of the vehicle security devices 10 installed in the neighboring vehicles) to establish a collaborative security group of a collaborative vehicle security system. That is, the neighboring vehicles (the vehicle security devices 10 installed in the neighboring vehicles) become the group members in the same collaborative security group. For example, as shown in FIG. 2, the vehicle security device #2 joins two independent collaborative security groups 60 and 70. In this case, the vehicle security device #2 has a relatively low probability of losing communications with 2 independent collaborative security groups 60 and 70 at the same time. In this embodiment, all collaborative security groups and vehicles in the parking lots can signally connect to each other via the wireless local area network (in a grid-like manner), thereby ensuring the reliability and effectivity of the communications and connections between all vehicles in the collaborative security groups. For example, the vehicle security device #2 scans the available communication signal with the strongest intensity from the communication module 2 of the neighboring vehicle security device #N, then randomly requests to join the collaborative security group 60. In addition, the vehicle security device #2 can accept the request from another neighboring vehicle security device #N+1 to join another collaborative security group 70. These collaborative security groups can be established only if the communication signal emitted by the communication module 2 of the vehicle security device #2 has the strongest intensity in this area. In this embodiment, the vehicle security device #2 joins two collaborative security groups (W1=2) at the same time, including the collaborative security groups 60 and 70. Each collaborative security group contains four vehicle security devices 10 (or four vehicles) (W2=4), so that the total number of primary group members in the collaborative security groups 60 and 70 (the first layer of the vehicle security device #2) can be calculated based on the following equation:

W1*(W2−1)=2*(4−1)=6.

In this embodiment, each vehicle security device 10 in the collaborative security group 60 further joins another independent collaborative security group. Taking the vehicle security device #N as an example, the vehicle security device #N may be the vehicle security device #S of another collaborative security group 99. Of course, the collaborative security group connections of the vehicle security devices #1 and #3 can be established based on the above example. In this case, the collaborative security group 99 is defined as the second layer of the vehicle security device #2. If the group members of the first and second layers of the of the vehicle security device #2 are all invited to the warning alarm action corresponding to an abnormal event, the total amount of the invited group members can be calculated based on the following equation:

W1*(W2−1)*W2=2*(4−1)*4=24.

The detection module 5 of the vehicle security device 10 detects possible abnormal events such as vehicle displacement, door opening, vehicle seat occupied at any time for the vehicle parked in the parking space, and initiates an abnormal alarm and broadcasts them to all vehicle security devices 10 in the collaborative security group when detecting out any of the abnormal events. Therefore, all the vehicle security devices 10 can together turn on the loud warning sound to deter the thief. The abnormal alarm is also transferred to the remote vehicle owner, other vehicle owners of the same collaborative security group, and the parking lot manager at the same time, so that the vehicle owners and parking lot manager can take appropriate rescue actions based on the types of abnormal alarms received. In general, the thief usually steals one car after one another and expects to return with a full load, so the vehicle owners who receive the notification of abnormal alarm may consider that his/her vehicle may be the next target of the thief and is willing to return to the parking lots to check what is happened and to assist to relieve the abnormal alarm. In some cases, the multiple vehicle owners or managers who return to the parking lots can collaborate with police to catch the thief or robber. Car robbing and or kidnapping incidents in parking lots have been heard frequently. If the vehicle owners participate in the collaborative security group of the collaborative vehicle security system of the present disclosure, it is possible to prevent the occurrence of unfortunate incidents or reduce personal and financial losses by broadcasting and transferring the abnormal alarms to all of the group members.

The sharing of abnormal alarms in the above-mentioned example is achieved through a small wireless local area network in which all the vehicle security devices 10 are mutually connected in grid-like manner, and the central control host 20 does not participate in this system. In this embodiment, the vehicle security device 10 can further output the abnormal alarm to the remote user electronic device via the Internet connection ability of the central control host 20. This completes the broadcasting and transferring through the small wireless local area network and the remote Internet. The wireless local area network technology used by the communication module 2 can be Wi-Fi, Zigbee, Bluetooth, LoRa, Short Distance Radio (SDR), etc. While considering the transmission distance and bandwidth requirements, Wi-Fi can be prioritized choice.

The communication module 2 of the central control host 20 can externally connect the user electronic device 40 and the backup server 50 via the cloud network 30, so as to output the abnormal alarm to the user electronic device 40 and the backup server 50, or receive the control signal from the user electronic device 40 and the backup server 50. The user electronic device 40 may be a mobile communication device, such as a smart phone, a tablet computer, etc. In addition, the central control host 20 can also simultaneously upload information about the remaining number of individual parking spaces in the parking lots, parking garages, or curbside parking spaces to the backup server 50, so that it can uniformly control all parking lots or garages as well as the parking spaces. The Internet connection capability of the central control host 20 is prioritized by wired optical fiber or coaxial cable, and 3G, 4G or 5G telecommunication communication network can also be used to connect to the Internet.

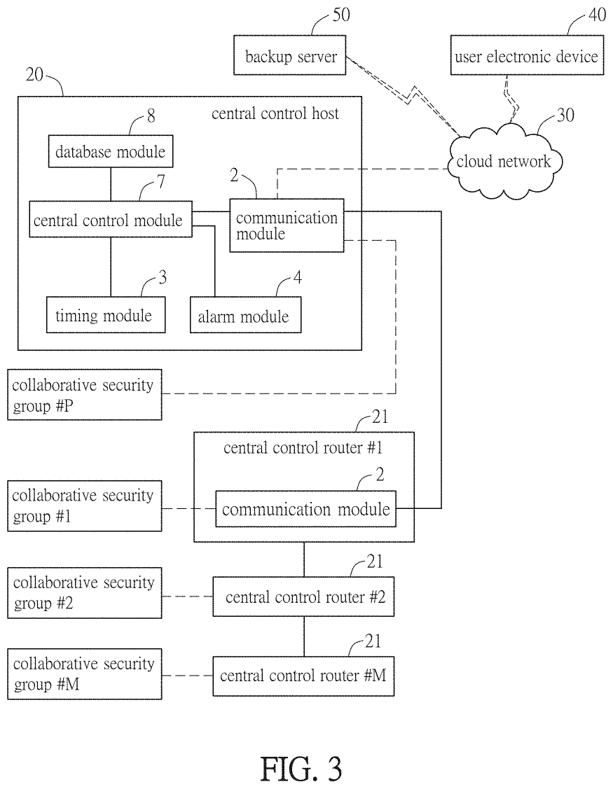

Referring to FIG. 3, the central control host 20 can operate alone, or cooperate with one or more central control routers 21 to expand the total amount of vehicle management in the parking lots, extend the distance of the reliable communication connection of the parking lots, and partition the parking management areas. This disclosure is also applicable to the curbside parking and payment system managed by the government unit, which can save the salary expenditure of the billing staff. The communication modules 2 are connected one after one in series and provide routing services for network packets. Only one of the communication modules 2 directly communicates with the communication module 2 of the central control host 20. Each central control router 21 is communicated to the corresponding one of the collaborative security groups. When an abnormal alarm occurs in one collaborative security group, the abnormal alarm will be sent to the central control host 20 through the central control routers 21 in the form of network packets, and then it is uniformly judged by the central control host 20 and the appropriate actions will be taken. The central control routers #1 . . . #M can be set in the appropriate positions of a large surface parking lots to cover the reliable communication connection distances of all collaborative security groups within the area. In addition, the central control routers #1 . . . #M can be set in different floors of a parking tower.

Referring to FIGS. 1 and 3, the timing module 3 is configured to obtain a time stamp, which can record the time of vehicle entering and leaving the parking lots, the time of occurrence of abnormal alarm, and the time of relieving the abnormal alarm by the group member of the collaborative security group or the parking lot manager.

Referring to FIGS. 1 and 3, the alarm module 4 is controlled by the control module 1 to display the corresponding LED lights according to the type of abnormal alarm sent from the detection module 5, and at the same time emit a corresponding warning sound through the buzzer. The type of abnormal alarm may be vehicle displacement, door opening, vehicle seat occupied, etc. In addition, with different LED lights and/or warning sounds, it can be further distinguished whether the source of the abnormal alarm is the vehicle itself or from a sharing event (from other group members).

As shown in FIGS. 1 and 3, the warning relieve module 6 is used to (1) reply the confirmation of agreeing to use the advance service of the collaborative security system to the central control host 20, wherein the green light may change from flashing for 5 times per second to flashing once per second in this procedure; (2) accept a relieve operation performed by the vehicle owner of the collaborative security group or the parking lot manager, wherein the time of performing the relieve operation will be recorded for determining to gift a gratitude bonus to the person who performed the relieve operation (e.g. the first person arrived the parking space of the alerting vehicle); and (3) pay the amount for this parking.

As mentioned above, the control module 1 receives the abnormal alarm from the detection module 5 through the communication module 2. After determining the type of the abnormal alarm in view of the preset collaborative security conditions, the alarm module 4 will output the corresponding LED light and the corresponding warning sound (by buzzer), and the abnormal alarm will also be broadcast to all the group members in the collaborative security group through the small wireless local area network of the collaborative security group. Afterwards, all the group members will turn on the loud warning sound to deter theft. Then, the abnormal alarm message can be sent to the remote user electronic devices, so that the vehicle owners and/or the parking lot manager can take immediate rescue action after checking the received message.

Besides, referring to FIGS. 1 to 3, the backup server 50 may include a database for recording (1) the registered information of the user (the vehicle and the vehicle security device) such as the user's contact information, the license plate number, and/or the automatic payment information; (2) the time information about the abnormal alarm occurrence and relieving the abnormal alarm; (3) the information about parking lot serial numbers, vehicle access and payment information, and information of available parking spaces, which can be provided to update in real time for the vehicle owners.

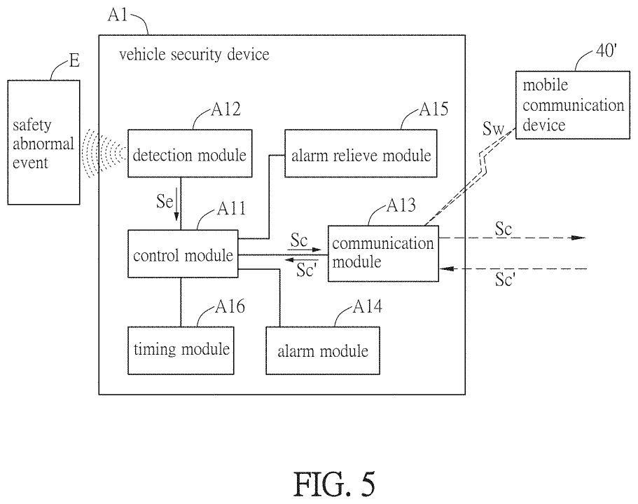

FIG. 5 is a schematic diagram showing a vehicle security device A1 according to a second embodiment of this disclosure. As shown in FIG. 5, the vehicle security device A1 comprises a control module A11, a detection module A12, a communication module A13, and an alarm module A14. In one aspect, the control module A11, the detection module A12, the communication module A13 and the alarm module A14 can be integrally configured in one housing to form the vehicle security device A1. In this aspect, the user can install the vehicle security device A1 at any proper position inside or outside the corresponding vehicle. In another aspect, the control module A11, the detection module A12, the communication module A13 and the alarm module A14 of the vehicle security device A1 are separated components. In this aspect, the user can install the control module A11, the detection module A12, the communication module A13 and the alarm module A14 at proper positions inside or outside the corresponding vehicle. Of course, the control module A11, the detection module A12, the communication module A13 and the alarm module A14 of the vehicle security device A1 can also be partially integrated and partially separated, and this disclosure is not limited.

As shown in FIG. 5, the detection module A12 is electrically or signally connected to the control module A11, and is configured to detect at least one safety abnormal event E of the corresponding vehicle. In this embodiment, the control module A11 can be, for example but not limited to, a controller or a micro processer, and the detection module A12 can be, for example but not limited to, a vibration sensor, a hall sensor, a pressure sensor, a gyroscope, a GPS device, etc. In addition, the detected at least one safety abnormal event E may be, for example but not limited to, vehicle displacement, door opening, vehicle seat occupied, etc. For example, when the vehicle moves, it may trigger the vibration sensor, gyroscope or GPS device. Therefore, the detection module A12 will determine that a safety abnormal event E is detected out. In addition, when the door is opened, it may trigger the vibration sensor and/or the Hall sensor, so the detection module A12 will determine that a safety abnormal event E is detected out. In addition, when a person is sitting on the car seat, the vibration sensor and/or the pressure sensor may be triggered, so the detection module A12 will determine that a security abnormal event E is detected out. It should be noted that the above illustrations are only examples, and the present disclosure is not limited to the above aspects.

As shown in FIG. 5, the communication module A13 is electrically or signally connected to the control module A11 and is configured to optionally output at least one collaborative alarm activation signal Sc or receive at least one collaborative alarm activation signal Sc′. In this embodiment, the control module A11 may control the communication module A13 to output at least one collaborative alarm activation signal Sc, or the communication module A13 may receive at least one collaborative alarm activation signal Sc′ from outside (e.g. another vehicle security device) and send the received collaborative alarm activation signal Sc′ to the control module A11. In this embodiment, the communication mode of the communication module A13 can be, for example but not limited to, Wi-Fi, Zigbee, Bluetooth, LoRa, Short Distance Radio (SDR), and/or 3G, 4G or 5G telecommunication communication network.

Referring to FIG. 5, the alarm module A14 is configured to output a warning alarm. In this embodiment, the warning alarm outputted by the alarm module A14 can be, for example but not limited to, a sound alarm, a light alarm, a vibration alarm, or the likes. Furthermore, the intensity of the warning alarm outputted by the alarm module A14 is variable. For example, the warning alarm can be a sound alarm with different volumes, a light alarm with different light colors or different brightness, or a vibration alarm with different vibration intensities.

In this embodiment, when the detection module A12 detects out at least one safety abnormal event E, the control module A11 generates an abnormal alarm activation signal Se and a collaborative alarm activation signal Sc according to the detection result. Then, the alarm module A14 outputs the warning alarm according to the abnormal alarm activation signal Se, and the communication module A13 outputs the collaborative alarm activation signal Sc by broadcasting or signal transmission at the same time.

In addition, when the communication module A13 receives at least one collaborative alarm activation signal Sc′ from outside, the control module A11 controls the alarm module A14, according to the received collaborative alarm activation signal Sc′, to output the warning alarm.

In addition, as shown in FIG. 5, the vehicle security device A1 of this embodiment further comprises an alarm relieve module A15 for accepting a relieve operation to relieve the warning alarm outputted by the alarm module A14. Specifically, after the alarm module A14 outputs the warning alarm, the vehicle owner of the vehicle or any authorized person (e.g. the parking lot manager or other vehicle owners who use the same vehicle security devices) may rush to the alarm site (e.g. where the vehicle and the vehicle security device A1 are located) as soon as possible. After the safety abnormal event E is resolved, the person arrived the alarm site can perform a relieve operation on the alarm relieve module A15 to relieve the warning alarm outputted by the alarm module A14. For example, the relieve operation performed on the alarm relieve module Al5 can be inputting a password, sensing barcode, QR code or a chip, or the likes, but this disclosure is not limited thereto.

In addition, as shown in FIG. 5, the vehicle security device A1 of this embodiment further comprises a timing module A16 configured to provide at least one time stamp, which is corresponding to at least one of the safety abnormal event E, the collaborative alarm activation signal Sc or Sc′, the warning alarm, and the abnormal alarm activation signal Se. Specifically, when the detection module A12 detects out at least one safety abnormal event E, the timing module A16 can provide a time stamp for this safety abnormal event E. Accordingly, the vehicle owner or the authorized person can operate the user electronic device (e.g. a mobile phone) to retrieve the time point when the safety abnormal event E was happened.

In this embodiment, the communication module A13 can further retransmit the received collaborative alarm activation signal Sc′. In other words, when the communication module A13 receives the collaborative alarm activation signal Sc′ from outside, except for initiating the control module A11 to control the alarm module A14 to output the warning alarm, the communication module A13 further retransmits the received collaborative alarm activation signal Sc′ to the neighboring vehicle security device(s) Al. Accordingly, the neighboring vehicle security device(s) Al can also output the warning alarm(s) according to the collaborative alarm activation signal Sc′.

As mentioned above, the vehicle security device A1 outputs at least one warning signal Sw to a mobile communication device 40′ (or the user electronic device 40 as shown in FIG. 2), which can be, for example but not limited to, a mobile phone. In this embodiment, the warning signal Sw comprises at least one of the safety abnormal event E, the collaborative alarm activation signal Sc or Sc′, the warning alarm, and the abnormal alarm activation signal Se, and the corresponding time stamp.

In addition, a collaborative vehicle security system B of the second embodiment comprises a plurality of the above-mentioned vehicle security devices A1. For example, a plurality of vehicles are parked in a parking lots, and at least a part or all of the vehicles are respectively installed with the above-mentioned vehicle security devices A1. When one of the vehicle security devices outputs the collaborative alarm activation signal Sc, another one of the vehicle security devices receives the collaborative alarm activation signal Sc, and outputs the warning alarm according to the received collaborative alarm activation signal Sc.

In this embodiment, the intensity of the warning alarm is variable based on the distance between the vehicle security device A1 outputting the warning alarm and a signal source of the collaborative alarm activation signal Sc (i.e., the vehicle security device A1 detects out the safety abnormal event E and outputs the collaborative alarm activation signal Sc). In this embodiment, the collaborative vehicle security system B further gifts a gratitude bonus to the user (the vehicle owner or parking lot manager) who performed the relieve operation with the alarm relieve module A15. In this embodiment, the collaborative vehicle security system B further comprises a database DB recording registration information of each vehicle security device A1. Herein, the warning signal further comprises the registration information of the vehicle security device A1, which outputs the collaborative alarm activation signal Sc.

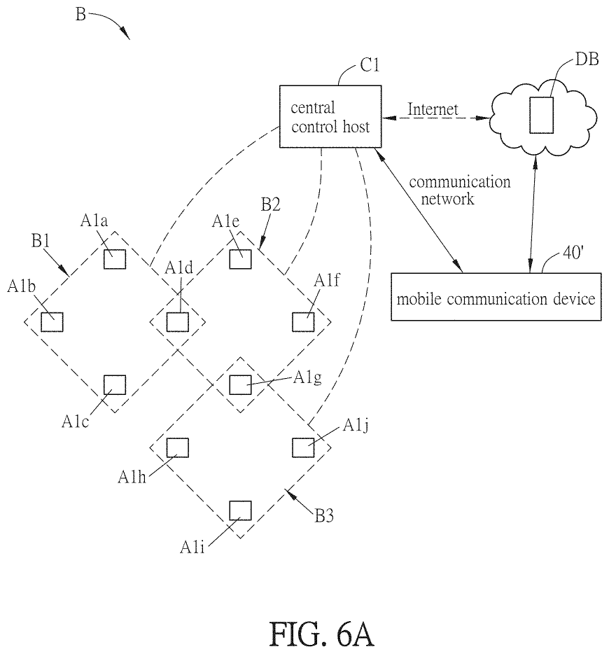

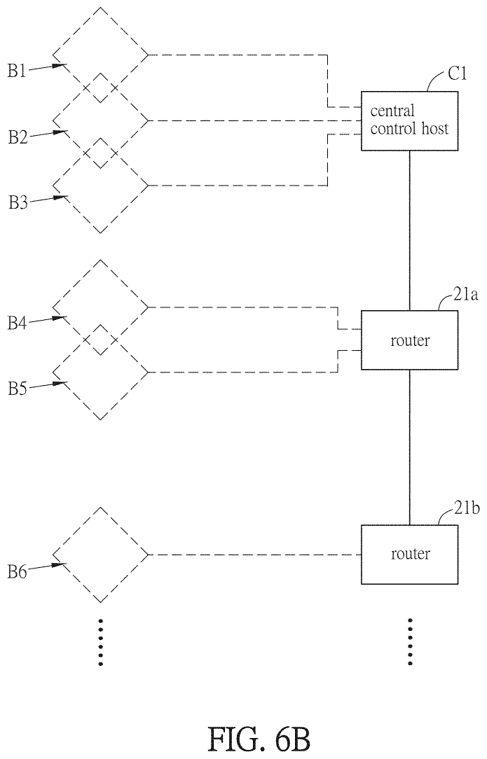

To make this disclosure more comprehensive, the detail operation of the collaborative vehicle security system B of this embodiment will be described with reference to FIG. 6A. Herein, FIG. 6A is a schematic diagram showing the collaborative vehicle security system B according to the second embodiment of this disclosure.

Referring to FIGS. 5 and 6A, a vehicle owner installed a vehicle security device A1a on his/her vehicle. After this vehicle is parked in a parking lots, the communication module A13 of the vehicle security device A1a can communicate with the neighboring vehicles within a certain neighboring region. For example, the communication module A13 of the vehicle security device A1a communicates with the communication modules A13 of the vehicle security devices A1b, A1c and A1d in the neighboring vehicles, and these vehicle security devices A1a, A1b, A1c and A1d will together form a collaborative security group B1 of the collaborative vehicle security system B and become the group members of the same collaborative security group B1. Similarly, the collaborative vehicle security system B also includes other collaborative security groups B2 and B3. As shown in FIG. 6A, the vehicle security device A1d joins two independent collaborative security groups B1 and B2, and the vehicle security device A1g joins two independent collaborative security groups B2 and B3. In addition, the collaborative security groups B1, B2 and B3 as well as the vehicle security devices A1a˜A1j thereof are signally connected to the central control host C1 of this parking lots. The central control host C1 can access a database DB via Internet so as to obtain the related registration information of the vehicle security devices A1a˜A1j. Moreover, the vehicle security devices A1a˜A1j can transmit information packets to the mobile communication device 40′ through the central control host C1 via the Internet. In addition, the vehicle security devices A1a˜A1j can send short messages to the mobile communication device 40′ through the central control host C1 via the communication network. Of course, each of the vehicle security devices A1a˜A1j can directly communicate with the mobile communication device 40′ of the corresponding vehicle owner via, for example, Internet or communication network. To be noted, the configurations and functions of the collaborative vehicle security system B of the second embodiment can refer to those of the collaborative vehicle security system of the first embodiment as shown in FIG. 2, so the detailed descriptions thereof will be omitted.

For example, after the collaborative security groups B1, B2 and B3 are established, when one vehicle encounters an abnormal event (e.g., the detection module A12 of the vehicle security device A1a detects out a safety abnormal event E), the control module A11 of the vehicle security device A1a will generate an abnormal alarm activation signal Se and a collaborative alarm activation signal Sc. Then, the alarm module A14 of the vehicle security device A1a outputs the warning alarm according to the abnormal alarm activation signal Se. At the meanwhile, the communication module A13 of the vehicle security device A1a outputs the collaborative alarm activation signal Sc to the other vehicle security devices A1b˜A1d of the same collaborative security group B1.

Next, after the communication modules A13 of the vehicle security devices A1b˜A1d receive the collaborative alarm activation signal Sc outputted from the communication module A13 of the vehicle security device A1a, the control modules All of the vehicle security devices A1b˜A1d control the corresponding alarm modules A14 to output warning alarms according to the received collaborative alarm activation signal Sc.

In addition, since the vehicle security device A1d is the group member in both of the collaborative security groups B1 and B2, the communication module A13 of the vehicle security device A1d can further retransmit the collaborative alarm activation signal Sc to other vehicle security devices A1e˜A1g in the collaborative security group B2. Afterwards, the control modules A11 of the vehicle security devices A1e˜A1g can control the corresponding alarm modules A14 to output warning alarms according to the received collaborative alarm activation signal Sc.

Similarly, since the vehicle security device A1g is the group member in both of the collaborative security groups B2 and B3, the communication module A13 of the vehicle security device A1g can further retransmit the collaborative alarm activation signal Sc to other vehicle security devices A1h˜A1j in the collaborative security group B3. Afterwards, the control modules A11 of the vehicle security devices A1h˜A1j can control the corresponding alarm modules A14 to output warning alarms according to the received collaborative alarm activation signal Sc.

In brief, when the detection module A12 of the vehicle security device A1a detects out the safety abnormal event E, not only the alarm module A14 of the vehicle security device A1a outputs the warning alarm, but also the alarm modules A14 of the vehicle security devices A1b˜A1j installed in the neighboring vehicles output the warning alarms. These large amount and loud warning alarms can provide an amplified warning function, and the thief cannot quickly eliminate the alarm sound. Therefore, the collaborative vehicle security system B of the present disclosure can indeed achieve the effect of anti-theft and anti-robbing

Moreover, in this embodiment, the intensity of the warning alarm can be variable based on the distance between the vehicle security device outputting the warning alarm and a signal source of the collaborative alarm activation signal Sc. Specifically, as shown in FIG. 6A, in the case that the detection module A12 of the vehicle security device A1a detects out a safety abnormal event E, the alarm module A14 of the vehicle security device A1a will output a warning alarm with a first level intensity, the other vehicle security devices A1b˜A1d in the collaborative security group B1 will output a warning alarm with a second level intensity, the other vehicle security devices A1e˜A1g in the collaborative security group B2 will output a warning alarm with a third level intensity, and the other vehicle security devices A1h˜A1j in the collaborative security group B3 will output a warning alarm with a fourth level intensity. Wherein, the first level intensity is the strongest intensity, and the fourth level intensity is the weakest intensity. For example, the alarm module A14 of the vehicle security device A1a outputs the loudest alarm sound, the most obvious light color (e.g. red light), the highest flashing frequency, or the like. The alarm module A14 of the vehicle security devices A1b˜A1d output the second loudest alarm sound, the second most obvious light color (e.g. green light), the second highest flashing frequency, or the like, and so on. Accordingly, when the vehicle owner or the authorized person (e.g., the parking lot manager or other vehicle owners) rushes to the alarm site (e.g. where the vehicle and the vehicle security device A1a are located), the exact location of the vehicle encountering the safety abnormal event E can be quickly confirmed, and the abnormal event can be quickly eliminated. After eliminating the abnormal event, the person arrived the alarm site can perform a relieve operation on the alarm relieve module A15 of the vehicle security device A1a to relieve the warning alarm outputted by the alarm module A14.

In addition, when the collaborative vehicle security system B of this embodiment is applied to a wide parking region, such as a large surface parking lots or a parking tower with multiple floors, some vehicle security devices may be far away from the central control host C1 and cannot directly signally connect to the central control host C1. In this case, one or more routers can configured to expand the total amount of vehicle management in the parking lots, extend the distance of the reliable communication connection of the parking lots, and partition the parking management areas. As shown in FIG. 6B, the collaborative vehicle security system B is configured with a plurality of routers 21a and 21b, which are signally connected to the central control host C1. For example, the routers 21a and 21b can be individually signally connected to the central control host C1 by wireless or wired method, or the routers 21a and 21b can be signally connected to the central control host C1 one after one in series. As shown in FIG. 6B, the collaborative security groups B1, B2 and B3 are directly signally connected to the central control host C1, the collaborative security groups B4 and B5 are signally connected to the router 21a and then connected to the central control host C1 through the router 21a, and the collaborative security group B6 is signally connected to the router 21b and then connected to the central control host C1 through the routers 21a and 21b. Taking a parking tower as an example, the central control host C1 is installed at the entrance of the first floor of the parking tower, and each floor is configured with a corresponding router. For example, in a 12-floor parking tower, the second to twelfth floors are each configured with one router (totally 11 routers are configured). In this case, the vehicles parking at each floor can together form one or more collaborative security groups, and the vehicle security devices of this floor can signally connected to the central control host through the corresponding router. The configuration of the router can refer to the related description of the embodiment as shown in FIG. 3, so the detailed descriptions thereof will be omitted.

In summary, the collaborative vehicle security system and vehicle security device of this disclosure can establish the communication connections between the neighboring vehicles in the parking lots or garages, and the neighboring vehicles with communication connections can be grouped as one collaborative security group. Accordingly, the group members (the vehicles or the vehicle security devices) of the collaborative security group can share the information such as the safety abnormal event, the collaborative alarm activation signal, and/or the abnormal alarm activation signal. When one of the vehicles (vehicle security devices) senses the safety abnormal event, it will share the alarm activation signal with other vehicles (vehicle security devices) in the same collaborative security group, and these vehicles (vehicle security devices) will output warning alarms at the same time. At this time, the loud warning alarms (from multiple vehicles) can deter thieves and stop the possible crime events. In addition, the collaborative alarm activation signal can be transmitted or used to notify other users of the same collaborative security group and the manager of parking lot or garages, so that the users and manager can immediately and appropriately act based on the received collaborative alarm activation signal to eliminate the abnormal alarm. This is a multiple-to-multiple creative value-added anti-theft service. In general, the thief usually steals one car after one another and expects to return with a full load. Therefore, by sharing the abnormal alarm, the vehicle invaded by the thief can immediately receive the first-moment loud deterrent support from all other vehicles in the same collaborative security group. Besides, the other vehicle owners in the collaborative security group(s) are also afraid that their properties may be the next target of theft, so of course they are willing to share the abnormal alarms with other vehicle owners who do not know each other. According the system of this disclosure, there will be multiple vehicles turning on the loud warning alarms to deter thieves, and then the multiple vehicle owners may return to the parking lots to check what is happened, confirm and/or help eliminate abnormal alarm, and the multiple vehicle owners can collaborate with police at critical moment to catch the thief

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A vehicle security device applied to a vehicle, comprising:
a control module installed in the vehicle;
a detection module connected to the control module and configured to detect at least one safety abnormal event of the vehicle;
a communication module connected to the control module and configured to optionally output or receive at least one collaborative alarm activation signal; and
an alarm module configured to output a warning alarm;
wherein, when the detection module detects out the safety abnormal event, the control module generates at least one abnormal alarm activation signal and the collaborative alarm activation signal, the alarm module outputs the warning alarm according to the abnormal alarm activation signal, and the communication module outputs the collaborative alarm activation signal;
wherein, when the communication module receives the collaborative alarm activation signal, the alarm module outputs the warning alarm according to the collaborative alarm activation signal.

2. The vehicle security device of claim 1, further comprising:
a timing module configured to provide at least one time stamp, which is corresponding to at least one of the safety abnormal event, the collaborative alarm activation signal, the warning alarm, and the abnormal alarm activation signal.

3. The vehicle security device of claim 1, wherein the communication module further retransmits the received collaborative alarm activation signal.

4. The vehicle security device of claim 1, wherein the communication module outputs at least one warning signal to a mobile communication device, and the warning signal comprises at least one of the safety abnormal event, the collaborative alarm activation signal, the warning alarm, and the abnormal alarm activation signal.

5. A collaborative vehicle security system, comprising:
a plurality of vehicle security devices, wherein each of the vehicle security devices is applied to a vehicle and comprises a control module, a detection module, a communication module and an alarm module, the control module is installed in the vehicle, the detection module is connected to the control module and configured to detect at least one safety abnormal event of the vehicle, the communication module is connected to the control module and configured to optionally output or receive at least one collaborative alarm activation signal, and the alarm module is configured to output a warning alarm; wherein when the detection module detects out the safety abnormal event, the control module generates at least one abnormal alarm activation signal and the collaborative alarm activation signal, the alarm module outputs the warning alarm according to the abnormal alarm activation signal, and the communication module outputs the collaborative alarm activation signal; and when the communication module receives the collaborative alarm activation signal, the alarm module outputs the warning alarm according to the collaborative alarm activation signal;
wherein, when one of the vehicle security devices outputs the collaborative alarm activation signal, another one of the vehicle security devices receives the collaborative alarm activation signal, and outputs the warning alarm according to the received collaborative alarm activation signal.

6. The collaborative vehicle security system of claim 5, wherein each of the vehicle security devices further comprises a timing module configured to provide at least one time stamp, and the time stamp is corresponding to at least one of the safety abnormal event, the collaborative alarm activation signal, the warning alarm, and the abnormal alarm activation signal.

7. The collaborative vehicle security system of claim 5, wherein an intensity of the warning alarm is variable based on a distance between the vehicle security device outputting the warning alarm and a signal source of the collaborative alarm activation signal.

8. The collaborative vehicle security system of claim 5, wherein the another one of the vehicle security devices further retransmits the received collaborative alarm activation signal.

9. The collaborative vehicle security system of claim 5, wherein each of the vehicle security devices outputs at least one warning signal to a mobile communication device, and the warning signal comprises at least one of the safety abnormal event, the collaborative alarm activation signal, the warning alarm, and the abnormal alarm activation signal.

10. The collaborative vehicle security system of claim 9, wherein each of the vehicle security devices further comprises an alarm relieve module, a user of the mobile communication device moves toward the vehicle security device outputting the warning alarm according to the received warning signal and performs a relieve operation to relieve the warning alarm of the vehicle security device, and the collaborative vehicle security system further gifts a gratitude bonus to the user who performed the relieve operation.

11. The collaborative vehicle security system of claim 9, further comprising:
a database recording registration information of each of the vehicle security devices, wherein the warning signal further comprises the registration information of the vehicle security device outputting the collaborative alarm activation signal.

12. The collaborative vehicle security system of claim 9, further comprising:
at least one central control host; and
at least one router signally connecting to the central control host;
wherein, each of the vehicle security devices is signally connected to the central control host directly or signally connected to the central control host through the router, so that the vehicle security device outputs the warning signal to the corresponding mobile communication device via the central control host.

13. The collaborative vehicle security system of claim 12, wherein the central control host provides a parking-area partition function, and the routers are arranged in different parking areas, respectively.
